(19) United States
(12) Patent Application Publication
(10) Pub. No.: US 2002/0010727 A1
(43) Pub. Date: Jan. 24, 2002

(54) AREA EFFICIENT FIR FILTER WITH PROGRAMMABLE COEFFICIENTS

(76) Inventors: GREGORY A. HUGHES, BETHLEHEM, PA (US); RICHARD LAWRENCE MCDOWELL, CHALFONT, PA (US)

Correspondence Address: MICHAEL B FEIN, SCHNADER HARRISON SEGAL & LEWIS, SUITE 3600, 1600 MARKET STREET, PHILADELPHIA, PA, 19103

(21) Appl. No.: 09/160,408

(22) Filed: Sep. 25, 1998

(51) Int. Cl. G06F 17/00

(52) U.S. Cl. 708/319

(57) ABSTRACT

The present invention is directed to an FIR filter for filtering sample values, which may include an adder circuit storing a plurality of coefficient values to be used in the FIR filter and for combining the samples values and the coefficient value to produce a combination value; and a memory circuit connected to the adder circuit for storing the combination value and for inputting at least a portion of the combination value back into the adder circuit to be combined with the sample values and the coefficient value. The present invention may also include a coefficient input circuit for inputting and storing a plurality of coefficient values to be used in the FIR filter; an ADC converter input circuit for inputting the sample values from the ADC converter; and an output circuit for outputting at least a portion of said combination value from the FIR filter. In the FIR filter of the present invention the coefficient values may be the same or different.

### BACKGROUND OF THE INVENTION

1. Field of the Invention

The present invention is directed to time varying finite impulse response (FIR) filters for communications systems, particularly to an area efficient FIR filter having programmable coefficients, and more particularly to an area efficient FIR filter having the multiplication and partial-sum-addition finctions mapped to a single adder/accumulator through time multiplexing.

2. Description of the Prior Art

Time varying FIR filters are often used in communications systems, such as cordless telephones, telecommunications systems, digital devices, and the like, to implement sample rate conversions. Conventional FIR filters typically include one or more multipliers, multiple accumulators, data storage elements to store the system coefficients, and a delay circuit or memory to store previous input words.

A decimation filter is one type of FIR filter in which the sampling frequency associated with the digital signal is changed and the frequency spectrum of the original digital signals are adapted to this changed sampling frequency. The original sampling frequency is reduced by the decimation factor, q. The filter length, N, of the filter determines the number of coefficients considered. The filter length determines the amount to which unwanted frequency components are suppressed and the extent to which “aliasing” of the signal is prevented.

Often times, in FIR filters which have a multiple accumulator hardware architecture (MACs), such as a DSP core, the coefficients are restricted to powers of two so that a shifter can be used instead of the multiplier. However, MACs are extremely costly in terms of die area. This is due primarily to the fact that multipliers require a large number of cells. The conventional method of replacing the multiplier by a shifter will reduce the surface area required on the fabricated chip, but has the significant disadvantage that it limits the filter coefficients to powers of two.

Accordingly, a new FIR filter is needed that is area efficient, has no multiplier, and a minimum number of data storage elements; yet is flexible enough that the coefficients are programmable and not limited to powers of two.

### Summary of the Invention

The present invention is directed to an FIR filter for filtering sample values, which may include an adder circuit storing a plurality of coefficient values to be used in the FIR filter and for combining the samples values and the coefficient value to produce a combination value; and a memory circuit connected to the adder circuit for storing the combination value and for inputting at least a portion of the combination value back into the adder circuit to be combined with the sample values and the coefficient value. The present invention may also include a coefficient input circuit for inputting and storing a plurality of coefficient values to be used in the FIR filter; an ADC converter input circuit for inputting the sample values from the ADC converter; and an output circuit for outputting at least a portion of said combination value from the FIR filter. In the FIR filter of the present invention the coefficient values may be the same or different.

The FIR filter of the present invention operates by storing a first combination value and a second combination value in a memory; inputting a sample value into an adder circuit; inputting the first combination value into the adder circuit; repeatedly adding the sample value and the first combination value the number of time represented by a first of a plurality of coefficients to obtain a first result; replacing the first combination value in the memory with the result; inputting a next sample value into the adder circuit; inputting the second combination value into the adder circuit; repeatedly adding the next sample value and the second combination value the number of time represented by a second of the plurality of coefficients to obtain a second result; replacing the second combination value in the memory with the second result; repeating these steps for each of the coefficients; outputting the first combination value; replacing the first combination value with the second combination value; and continuously repeating these steps for all of the sample values.

### BRIEF DESCRIPTION OF THE DRAWINGS

FIG. 1 is a schematic illustrating the components of an integrated chip FIR filter in accordance with aspect of the preferred embodiment of the invention.

### DETAILED DESCRIPTION

The present invention will be understood more fully from the detailed description given below and from accompanying drawings of preferred embodiments of the invention, which, however, should not be taken to limit the invention to a specific embodiment, but are for explanation and understanding only.

In one preferred embodiment of the present invention, a FIR filter is implemented through the use of a series of MAC operations. In many applications of FIR filters, the achievable processing rates far exceed the data sampling rate. If the operation clock is made faster than the sampling clock, the multiply function can be mapped to an adder/accumulator by simply adding a given sample into the accumulated sum multiple times.

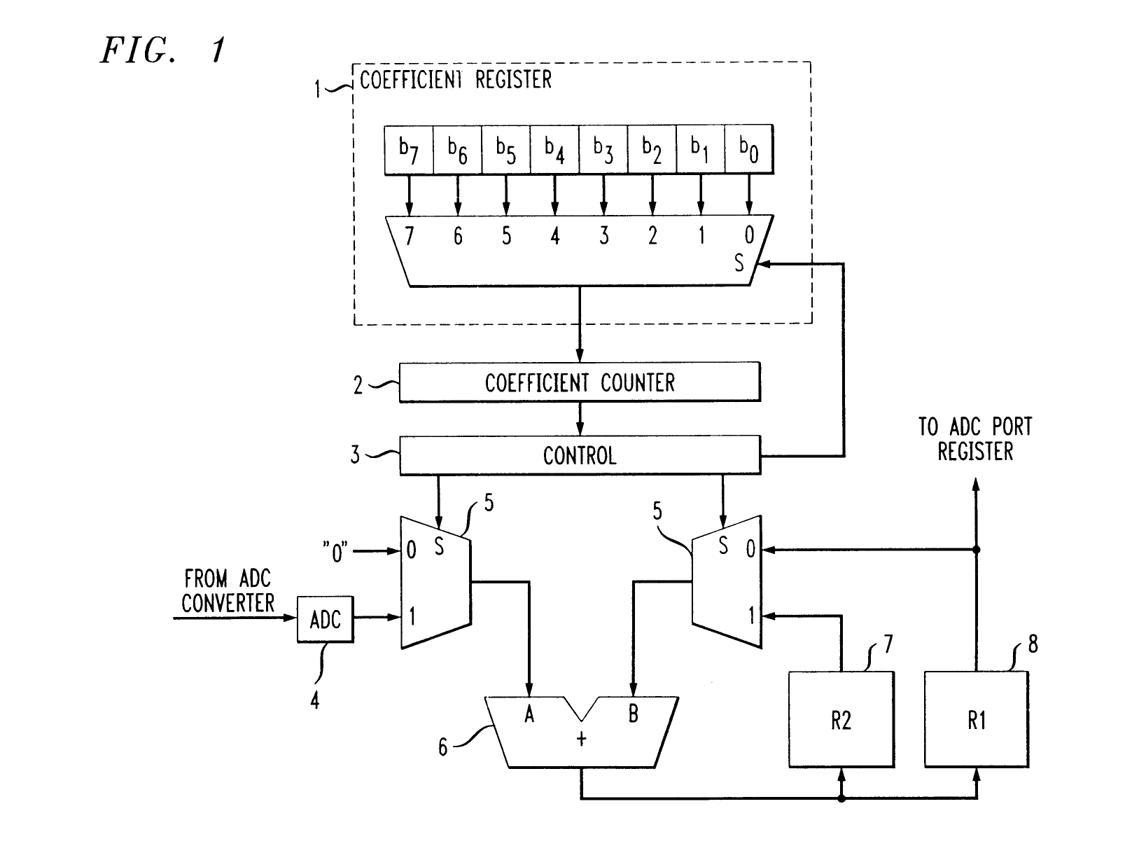

The present invention has the significant advantage that it removes area-hungry multipliers from the FIR filter, through the addition of some simple control circuitry. Moreover, for filters using decimation, partial sum calculations can also be mapped into available cycles on the adder/accumulator, thereby minimizing the number of storage elements required for performing the filter calculations. The number of required storage elements is T/D, where T is the number of taps in the filter and D is the decimation ratio. A preferred embodiment of an FIR filter in accordance with aspects of the present invention is illustrated in FIG. 1. The preferred embodiment, and each of the components thereof may utilize any number of computing technologies well known to those of ordinary skill in the art, such as integrated circuit chips or discrete logic elements.

As shown in FIG. 1, an FIR filter in accordance with the present invention may include Coefficient Register 1, which contains coefficient parameters b₀-b₇. Each of coefficients b₀-b₇ are fed sequentially to Coefficient Counter 2 in a manner well known to those in the art. Control Logic 3 is used to combine coefficients b₀-b₇ with the samples values adc1, adc2, and adc3 received from the ADC converter (not shown) at ADC Register 4.

This is accomplished by inputting the output values from SIO Ports 5 to Adder 6 in a conventional manner. The output values at Ports 5 are the samples values from ADC Register 4 and Accumulator Registers 7 and 8. The values R1 and R2 in Accumulator Registers 7 and 8 are calculated as described in more detail below. The final output from Accumulator Register 8 is then outputted to the ADC Port Register (not shown), in a conventional manner.

The system of the present invention, as illustrated in FIG. 1, may operate in the following manner. The programmable FIR filter in accordance with the present invention takes the samples received from the appropriate ADC converter (not shown), which are stored in ADC Register 4 as for adc1, adc2, and adc3, and filters them to generate outputs to a first SIO Port 5. The sampling can be conducted at any number of sampling rates, and is conducted at 64 kHz in the embodiment shown in FIG. 1. The outputs may also be produced at any number of accumulator rates, with a rate of 16 kHz being used in the embodiment shown in FIG. 1.

The transfer fimction of the filter shown in FIG. 1 is:

H(z)=b₀ +b₁z⁻¹+b₂z⁻²+b₃z⁻³+b₄z⁻⁴+b₅z⁻⁵ +b₆z⁻⁶+b₇z⁻⁷

This can be transformed to the following difference equation,

y(n)=b₀x(n)+b₁x(n−1)+b₂x(n−2)+b₃x(n−3)+b₄x(−4)+b₅x(n−5)+b₆x(n−6+b₇x(n−7)

In the embodiment shown in FIG. 1, x(n) and y(n) are 64 kHz samples. Since the SIO ports can output samples at a 16kHz rate, only every fourth y(n) is actually required. That is, in the embodiment shown, the y(n) are decimated. This can be represented by the following difference equation, where k =4n and n =0, 1, 2, 3 . . .

y(k)=p(k) +q(k−1) where

p(k)=bₒx(k/4)+b₁x(k/4−1)+b₂x(k/4−3) and

q(k)=b₄x(k/4)+b₅x(k/4−1)+b₆x(k/4−2)+b₇x(k/4−3)

By taking advantage of the fact that the CODEC clock is faster than the sample rate, an FIR filter in accordance with aspects of the present invention only requires a single adder to compute the filter for a given channel. This is accomplished by mapping the coefficients (b₀-b₇) into multiple add cycles so that there is no need for a multiplier.

The equations described above show that decimation of the samples can be used advantageously in the present invention so that only two accumulator registers are required: one for the result to be output for a given frame (Accumulator Register 7), and a second to hold a partial result for use in the next frame (Accumulator Register 8).

In the embodiment shown in FIG. 1, the ADC Register 4 holds the samples outputted by the converter. Value R2 in Accumulator Register 8 is used to accumulate q(k) for use in the next CODEC frame. Value R1 in Accumulator Register 7 is initially loaded with q(k-l) and is used to accumulate y(k). Coefficient Counter 2 is used to control the number of times the sample value in ADC Register 4 is added to the appropriate value in Accumulator Register 7.

At the beginning of the CODEC frame, R1 is loaded with the value in R2, q(k-1), and R2 is cleared. Then, coefficient b₃ is loaded into Coefficient Counter 2 and the instruction R1=R1+ADC is executed b₃ times. Following this, coefficient b₇ is loaded into Coefficient Counter 2 and the instruction R2=R2+ADC is executed b₇ times.

Both Accumulator Register 7 and 8 hold their values for the remaining cycles in the sample period. At the start of the second sample period, coefficient b₂ is loaded into Coefficient Counter 2 and the instruction R2=R2+ADC is executed b₂ times. Then, coefficient b₆ is loaded into Coefficient Counter 2 and the instruction R2=R2+ADC is executed b₆ times. The instruction R1=R1+0 is then executed for the remaining cycles in the sample period.

Similarly, R1=R1+ADC is executed b₁, time in the third sample period and R2=R2+ADC is executed b5 times. Likewise, R1=R1+ADC is executed b₀ times in the fourth sample period, and R2=R2+ADC is executed b₄ times. At the end of the CODEC frame, the value in Ri, y(k), is outputted to the port register (not shown). A new CODEC frame then starts and the sequence is repeated, as shown in FIG. 1.

Several possible coefficient sets are shown in Table 1 below.

TABLE 1

| b₇ | b₆ | b₅ | b₄ | b₃ | b₂ | b₁ | b₀ | Comments |
|---|---|---|---|---|---|---|---|---|
| 0 | 0 | 1 | 1 | 2 | 2 | 1 | 1 | This is the filter shown in FIG. 1. |
| 0 | 0 | 0 | 0 | 2 | 2 | 2 | 2 | This filter averages samples in the current CODEC frame. |
| 1 | 1 | 1 | 1 | 1 | 1 | 1 | 1 | This filter averages sample in the current and previous |
| | | | | | | | | CODEC frames. |
| 0 | 0 | 0 | 0 | 0 | 0 | 0 | 1 | This filter returns the fourth sample in the current CODEC |
| | | | | | | | | frame and is right shifts by three places (a divide by 8) as |
| | | | | | | | | compared to the sample output for adc4. |

While this invention has been described in conjunction with specific embodiments thereof, it is evident that many alternatives, modifications, and variations will be apparent to those skilled in the art. Accordingly, the preferred embodiments of the invention set forth herein are intended to be illustrative, not limiting. Various changes may be made without departing from the spirit and scope of the invention as defined in the appended claims.

We claim:

1. An FIR filter for filtering sample values comprising:
(a) an adder circuit for storing a plurality of coefficient values to be used in said FIR filter and for combining said samples values and said coefficient values to produce a combination value; and
(b) a memory circuit connected to said adder circuit for storing said combination value and for inputting at least a portion of said combination value back into said adder circuit to be combined with said sample values and said coefficient value.

2. The FIR filter of claim 1, further comprising a coefficient input circuit for inputting said coefficient values to said adder circuit.

3. The FIR filter of claim 1, further comprising an ADC converter input circuit for inputting said sample values from an ADC converter.

4. The FIR filter of claim 1, further comprising an output circuit for outputting at least a portion of said combination value from said FIR filter.

5. The FIR filter of claim 2, wherein said coefficient input circuit comprises a coefficient register and a coefficient counter.

6. The FIR filter of claim 3, wherein said ADC converter input circuit comprises an ADC register.

7. The FIR filter of Claim 1, wherein said adder circuit is an integrated circuit comprising two or more SIO ports, adder logic and control logic.

8. The FIR filter of claim 1, wherein said coefficient values are the same.

9. The FIR filter of claim 1, wherein said coefficient values are different.

10. An FIR filter for filtering sample values from an ADC converter comprising:
(a) a coefficient register for inputting and storing a plurality of coefficient values to be used in said FIR filter;
(b) a ADC converter register for inputting said sample values from said ADC converter;
(c) adder logic circuitry having an adder input for receiving said coefficient values, an adder input for receiving said sample value, and an adder output for outputting the combination value of said coefficient values and said sample value;
(d) a memory connected to said adder output for storing said combination valueof said coefficient values and said sample values and for inputting at least a portion of said combination back into said adder circuit to be combined with said sample values and said coefficient values;
(e) an output circuit connected to said memory for outputting at least a portion of said combination value from said FIR filter; and
(f) control logic circuitry for inputting said coefficient values, said sample values, and said combination thereof into said adder logic circuitry and controlling the output thereof from said FIR filter.

11. The FIR filter of Claim 10, wherein said coefficient values are the same.

12. The FIR filter of claim 10, wherein said coefficient values are different.

13. A method of filtering sample values comprising the steps of:
(a) storing a first combination value and a second combination value in a memory;
(b) inputting a sample value into an adder circuit;
(c) inputting said first combination value into said adder circuit;
(d) repeatedly adding said sample value and said first combination value the number of time represented by a first of a plurality of coefficients to obtain a first result;
(e) replacing said first combination value in said memory with said result;
(f) inputting a next sample value into said adder circuit;
(g) inputting said second combination value into said adder circuit;
(h) repeatedly adding said next sample value and said second combination value the number of time represented by a second of said plurality of coefficients to obtain a second result;
(e) replacing said second combination value in said memory with said second result;
(j) repeating steps (b)-(d) for each of said coefficients; and
(k) outputting said first combination value.

14. The method of claim 13 further comprising the steps of:
(1) replacing said first combination value with said second combination value;
(m) continuously repeating steps (b)-(l).

15. The method of claim 13, wherein said plurality of coefficients have the same value.

16. The method of claim 13, wherein said plurality of coefficients have different values.
